(19) United States
(12) Patent Application Publication
(10) Pub. No.: US 2021/0328335 A1
(43) Pub. Date: Oct. 21, 2021

(54) ANTENNA, ARRAY ANTENNA, AND WIRELESS COMMUNICATION DEVICE

(71) Applicant: NEC CORPORATION, Tokyo (JP)

(72) Inventors: Keishi KOSAKA, Tokyo (JP); Eiji HANKUI, Tokyo (JP)

(73) Assignee: NEC Corporation, Tokyo (JP)

(21) Appl. No.: 17/052,932

(22) PCT Filed: May 13, 2019
(86) PCT No.: PCT/JP2019/018915

§ 371 Date: Nov. 4, 2020

(30) Foreign Application Priority Data
May 16, 2018 (JP) 2018-094384

(51) Int. Cl. H01Q 1/42; H01Q 19/10; H01Q 21/06; H01Q 1/02

(52) U.S. Cl. CPC H01Q 1/422; H01Q 1/02; H01Q 21/065; H01Q 19/10

(57) ABSTRACT

Provided is an antenna element resistant to loss of electrical performance even when water droplets become attached thereto. The antenna element of the present invention is provided with a conductor portion and is characterized in that, at a location on a surface of the conductor portion in which the field intensity during operation is stronger than in other locations, a first dielectric having a thickness of not less than 0.005λ is formed, wherein λ is the vacuum wavelength of the electromagnetic waves of an antenna operation frequency.

### TECHNICAL FIELD

The present invention relates to an antenna, an array antenna, and a wireless communication device.

### BACKGROUND ART

An antenna device includes a radome in order to prevent an influence of rain and the like when the antenna device is installed outside. An antenna element is installed in a space surrounded by the radome, a device casing, and a conductor reflection plate. The radome is configured as a non-conductor in order not to inhibit a radio wave transmitted and received by the antenna element.

However, when the antenna device is installed outside, moisture contained in air inside the radome may condense as a water droplet on an inner wall of the radome in response to a temperature difference between the inside and the outside of the radome.

Patent Literature 1 (PTL1) discloses a structure that prevents a water droplet condensing on an inner wall of a radome from dropping, and prevents a change in an electrical characteristic of a signal transmission line in the radome. In PTL1, a frequency sharing antenna device 1 includes an antenna element 15 and a triplate line 100, and is housed in a radome 10. When the frequency sharing antenna device 1 is installed outside, a water droplet W may be formed by condensation on an inner surface of the radome 10 due to a temperature difference between the inside and the outside of the radome 10. In PTL1, a water droplet receiving member 13 including a receiving surface 13c inclined in such a way as to cover an upper side of the triplate line 100 is provided. In this way, even when the water droplet W drops from an inner surface of an upper antenna cap 10a, the water droplet W is received by the receiving surface 13c, and the water droplet W further flows along an inclination of the receiving surface 13c and drops in a vertically downward direction in such a way as to avoid the triplate line 100.

Further, in an antenna module in Patent Literature 2 (PTL2), an additional dielectric is in contact with a surface of an antenna in order to change a frequency of the antenna later. A paragraph (0054) describes that the additional dielectric having a dielectric constant of 30 and a thickness of 2 mm is bonded to one side of the antenna.

Further, Patent Literature 3 (PTL3) is an invention of a wireless gauge device, but, as described in paragraphs (0002) to (0003) (background art), the wireless gauge device is attached to an inside of a garbage container and used for measuring a full level and a full rate of the garbage container, and includes a fullness sensor 210 (ultrasonic sensor), a controller 212, a wireless transceiver 214, and an antenna 204 on a printed circuit board 200 (FIGS. 2 and 3, and paragraphs (0033) and (0049)). The gauge is exposed to an environment having a temperature change, a physical impact, humidity, gas, and other chemical substance, and thus a protective layer 220 is provided on both sides of the antenna 204 for a purpose of protection. The protective layer has a thickness of 4 to 8 mm, and a material of the protective layer is a closed-cell plastic material made from polyethylene, polypropylene, or the like (claim 1 and paragraph (0025)). When FIGS. 2 and 3 are seen, the protective layer 220 is formed on the entire antenna 204. Patent Literature 4 (PTL4) relates to an array antenna, and describes that an antenna element of the array antenna includes a split ring conductor having a shape in which a part is cut by a split portion, and a feeding line conductor including one end electrically connected to the split ring conductor. Patent Literature 5 (PTL5) relates to a structure that houses an antenna, and describes a laminated structure in which a split ring layer, a dielectric layer, and a grid layer are laminated.

### CITATION LIST

### Patent Literature

[PTL1] International Publication No. WO2016/135854
[PTL2] Japanese Patent Application Laid-Open No. 2005-252661
[PTL3] Japanese Patent Application Laid-Open No. 2016-116219
[PTL4] International Publication No. WO2015/151430
[PTL5] Japanese Patent Application Laid-Open No. 2014-150433

### SUMMARY OF INVENTION

### Technical Problem

However, a water droplet in a radome may adhere to not only a transmission line as described in PTL1 but also to an antenna element. Then, electrical performance such as a band and radiation intensity of the antenna element itself changes.

The present invention has been made in view of the above-described problem. An object of the present invention is to provide an antenna element capable of suppressing a decrease in electrical performance due to adhesion of a water droplet, and a wireless communication device including the antenna element.

### Solution to Problem

The present invention is an antenna element including: a conductor portion, and a first dielectric having a thickness equal to or more than 0.005λ when a vacuum wavelength of an electromagnetic wave at an operation frequency of an antenna is λ and formed in a place of a surface of the conductor portion having higher electric field intensity during operation than that of another place.

### Advantageous Effects of Invention

The present invention is able to provide an antenna element capable of suppressing a decrease in electrical performance due to adhesion of a water droplet, and a wireless communication device including the antenna element.

### BRIEF DESCRIPTION OF DRAWINGS

FIG. 1 is a perspective view of an antenna 10 according to a first example embodiment of the present invention.

FIG. 2 is a perspective view of an antenna element 11 in FIG. 1.

FIG. 3 is a plan view when the antenna 10 is seen from a z-axis positive direction.

FIG. 4 is a plan view when the antenna 10 is seen from an x-axis negative direction.

FIG. 5 is a perspective view illustrating a modification example of the antenna element 11.

FIG. 6 is a top view illustrating a modification example of the antenna element 11.

FIG. 7 is a perspective view illustrating a modification example of the antenna element 11.

FIG. 8 is a front view illustrating a modification example of the antenna element 11.

FIG. 9 is a perspective view illustrating a modification example of the antenna element 11.

FIG. 10 is a top view illustrating a modification example of the antenna element 11.

FIG. 11 is a perspective view of an antenna element 21 according to a second example embodiment of the present invention.

FIG. 12 is a top view when an antenna 20 according to the second example embodiment is seen from the z-axis positive direction.

FIG. 13 is a top view illustrating a modification example of the antenna element 21.

FIG. 14 is a perspective view of an antenna 30 according to a third example embodiment of the present invention.

FIG. 15 is a schematic perspective view of a wireless communication device 400 according to a fourth example embodiment of the present invention.

FIGS. 16(A) to 16(C) are diagrams schematically illustrating one example of a circuit configuration of the wireless communication device 400.

FIG. 17 is a diagram illustrating a heat radiation path of heat generated in a communication circuit 401C.

FIG. 18 is a schematic perspective view illustrating a modification example of the wireless communication device 400.

FIG. 19 is a schematic perspective view illustrating a modification example of the wireless communication device 400.

FIG. 20 is a schematic plan view illustrating a modification example of the wireless communication device 400.

FIG. 21 is a schematic perspective view illustrating a modification example of the wireless communication device 400.

FIG. 22 is a perspective view of an antenna element 51 according to a fifth example embodiment of the present invention.

### EXAMPLE EMBODIMENT

Hereinafter, example embodiments of the present invention will be described by using drawings. Note that, in all of the drawings, a similar component is denoted by a similar reference sign, and description thereof will be appropriately omitted.

### First Example Embodiment

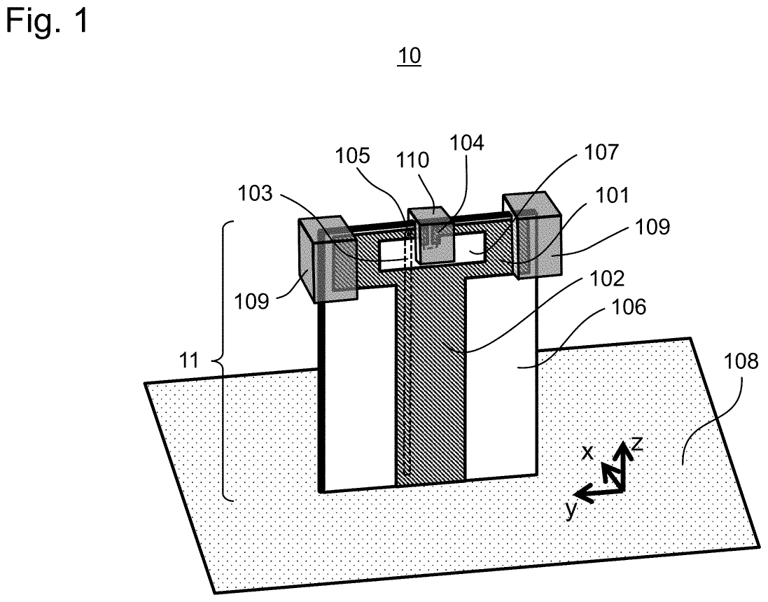

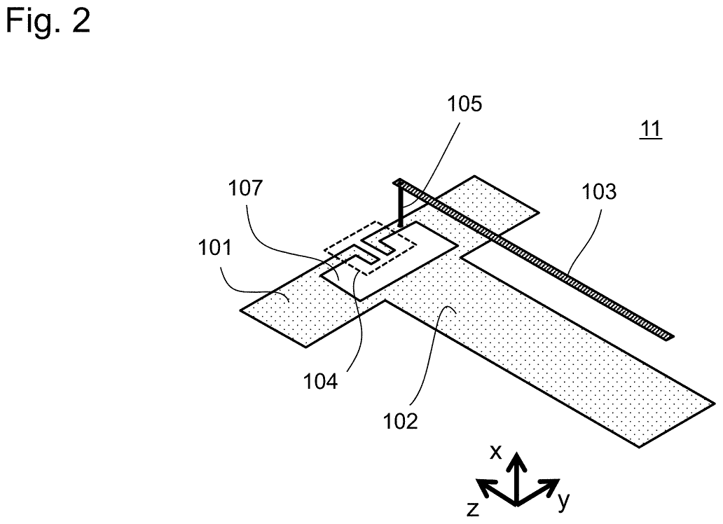

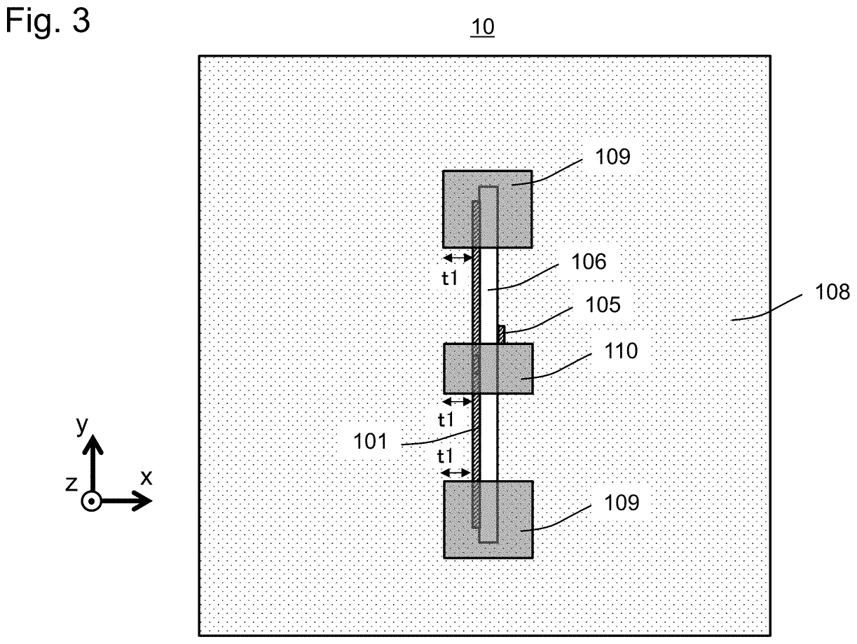

FIG. 1 is a perspective view illustrating one example of an antenna 10 according to a first example embodiment of the present invention. FIG. 2 is a perspective view of an antenna element 11 in FIG. 1. FIG. 3 is a plan view when the antenna 10 is seen from a z-axis positive direction. However, a dielectric substrate 106, a dielectric 109, and a dielectric 110 are omitted from FIG. 2 for simplification. In the present example embodiment, an operation frequency band of an antenna is a UHF band to an SHF band at a low frequency.

The antenna 10 includes the antenna element 11 disposed substantially parallel to a zy plane, and a conductive reflection plate 108 disposed substantially parallel to an xy plane. The reflection plate 108 reflects an electromagnetic wave emitted from the antenna element 11, and increases radiation intensity of the antenna element 11 toward a z-axis positive direction side.

The antenna element 11 is configured to include the dielectric substrate 106, a split ring portion 101 and a connection portion 102 (connection conductor) disposed on a front layer (surface on an x-axis negative direction side) of the dielectric substrate 106, a feeding line 103 disposed on a rear layer (surface on an x-axis positive direction side) of the dielectric substrate 106, a conductor via 105 that connects between different layers of the dielectric substrate 106, the dielectric 109 that covers a surface of both end portions in a y-axis direction of the split ring portion 101, and the dielectric 110 that covers a surface of a split portion 104.

The split ring portion 101 is a substantially C-shaped conductor in which a part on a circumference of a rectangular ring having a long side in the y-axis direction and a short side in the z-axis direction is cut by the split portion 104. The split portion 104 is provided in the vicinity of the center of the long side of the split ring portion 101 on a side (z-axis positive direction side) farther from the reflection plate 108.

The connection portion 102 is a conductor extending in the z-axis direction, includes one end connected to the vicinity of the center of the long side of the split ring portion 101 on a side (z-axis negative direction side) closer to the reflection plate 108, and includes another end portion connected to the reflection plate 108. The connection portion 102 electrically connects the split ring portion 101 and the reflection plate 108.

The feeding line 103 is a linear conductor, and includes one end connected to a portion on the long side of the split ring portion 101 on the side (z-axis positive direction side) farther from the reflection plate 108 via the conductor via 105. The feeding line 103 extends to a region facing the connection portion 102 across an opening 107 of the split ring portion 101 when seen from the x-axis direction. In other words, the feeding line 103 overlaps a region of the connection portion 102 surrounded by an outer edge when seen from the x-axis direction. Another end portion of the feeding line 103 is connected to an RF circuit (high frequency circuit), which is not illustrated.

With the configuration above, the feeding line 103 is capacitively coupled to the connection portion 102, thereby forming a transmission line in the region facing the connection portion 102. As a result, an RF signal generated by the RF circuit, which is not illustrated, is transmitted by the feeding line 103 and fed to the split ring portion 101.

The split ring portion 101, the connection portion 102, and the feeding line 103 that constitute the antenna element 11 are generally formed of a copper film on a dielectric substrate, but may be formed of another material that is a conductor, and may each be formed of the same material or a different material.

The dielectric substrate 106 that supports each conductor element of the antenna element 11, and the dielectric 109 and the dielectric 110 that cover the conductor surface may be formed of any material by any manufacturing process, and glass epoxy resin, ceramic, or the like can be used. Further, the dielectric substrate 106 that supports each conductor element of the antenna element 11 may also be formed of any material by any manufacturing process, and, for example, may be a printed circuit board using glass epoxy resin, may be an interposer substrate such as large scale integration (LSI), may be a module substrate using a ceramic material such as low temperature co-fired ceramics (LTCC), and may be, of course, a semiconductor substrate of silicon or the like.

Further, the reflection plate 108 is generally formed of a metal plate or a copper film bonded to a dielectric substrate, but may be formed of another material that is conductive.

Further, the conductor via 105 is generally formed by plating a through hole formed in the dielectric substrate 106 by a drill, but may be anything as long as the conductor via 105 can electrically connect between layers. For example, the conductor via 105 may be formed by using a laser via formed by laser, a copper line, and the like.

Further, the split ring portion 101 preferably has a shape having a long dimension in the y-axis direction as mentioned above in order to acquire excellent radiation efficiency. Herein, an example in which the split ring portion 101 is a rectangle is described as a typical example, but the split ring portion 101 having another shape does not have an influence on an essential effect of the present invention as long as the shape has a long dimension in the y-axis direction. For example, a shape of the split ring portion 101 may be an ellipse, a bow tie shape, or the like.

Further, the split ring portion 101 and the reflection plate 108 are preferably disposed at a distance of about ¼ of a wavelength in the z-axis direction. Thus, a length in the z-axis direction of the connection portion 102 is preferably about ¼ of the wavelength. At this time, an electromagnetic wave radiated from the split ring portion 101 into the z-axis positive direction and an electromagnetic wave radiated into the z-axis negative direction and reflected by the reflection plate 108 reinforce each other, and thus an antenna gain in the z-axis positive direction can be improved. However, a z-direction distance between the split ring portion 101 and the reflection plate 108 may be a value other than ¼ of the wavelength, and, in this case, design of the split ring portion may be adjusted in such a way as to acquire an excellent radiation characteristic. Even in such a case, an essential effect of the present invention is not influenced.

Next, action and an effect of the present example embodiment will be described. According to the antenna 10 in the present example embodiment, the split ring portion 101 functions as an LC series resonance circuit (split ring resonator) in which an inductance by a current flowing along a ring and a capacitance generated between conductors facing each other in the split portion 104 are connected in series. In the vicinity of a resonance frequency of the split ring resonator, a great current flows through the split ring portion 101, and the split ring portion 101 operates as an antenna by a part of current components contributing to radiation.

At this time, the inventors have found that an electric field having intensity greater than that of another portion is generated near the split portion 104 and near both end portions in a longitudinal direction (y-axis direction) of the split ring portion 101.

Since the capacitance generated between the conductors as mentioned above causes resonance in the split portion 104, it is clear that an electric field concentrates during the resonance. Further, for the both end portions in the longitudinal direction of the split ring portion 101, a relatively great potential difference is generated between the both end portions by a current flowing along the ring in the split ring portion 101 having the longitudinal direction, and, as a result, it has been found that an electric field stronger than that in another portion except for the both end portions in the longitudinal direction of the split ring portion 101 is generated.

Herein, when it is assumed that a water droplet adheres to the antenna 10, it is clear that the dielectric 109 and the dielectric 110 hinder a water droplet from directly adhering to a place having high electric field intensity in the antenna element 11. The inventors have found that the dielectric 109 and the dielectric 110 prevent a water droplet from directly adhering to a place having electric field intensity higher than that of another place of the antenna 10, and thus deterioration of electrical performance of the antenna 10 such as a band (S 11) and a radiation characteristic due to a water droplet can be suppressed. Even when a water droplet adheres to another place having relatively low electric field intensity in the antenna element 11, an influence of the water droplet on an electric field is small, and thus the electrical performance of the antenna 10 rarely deteriorates.

Next, why deterioration of an antenna characteristic can be suppressed by preventing a water droplet from directly adhering to an antenna surface will be described. When an antenna operates, there are mainly an electromagnetic field (nearby electromagnetic field) that remains and resonates in the antenna and near a periphery of the antenna and an electromagnetic field (progressive electromagnetic wave) that leaks from there and progresses to a distance place. Then, a change in surrounding environment that has an influence on the nearby electromagnetic field changes a characteristic such as a resonance frequency of the antenna. The intensity of the nearby electromagnetic field is greatly attenuated in proportion to a distance from the antenna. Thus, an influence of a water droplet greatly changes depending on whether the water droplet adheres to the surface of the dielectrics 109 and 110 or to the surface of an antenna conductor. Thus, even when a water droplet adheres to the surface of the dielectric, an influence of the water droplet on the nearby electromagnetic field can be suppressed as compared to a case where the water droplet directly adheres to the surface of the antenna conductor, and deterioration (deviation) of the antenna characteristic such as a resonance frequency can be suppressed.

Note that an influence of a water droplet can also be reduced by covering the entire antenna with an extremely thick dielectric, but such a thick dielectric causes deterioration of antenna performance due to a material loss and difficulty of manufacturing. The dielectric 109 and the dielectric 110 according to the present example embodiment achieve suppression, with a minimum dielectric, of deterioration of the electrical performance of the antenna 10 due to a water droplet.

Further, the split portion may have electric field intensity greater than that of the both end portions in the longitudinal direction depending on design of the antenna. Thus, when either of the both end portions in the longitudinal direction and the split portion is selected, the dielectric may be formed on only the split portion. Furthermore, the dielectric may be formed on one of the both end portions in the longitudinal direction instead of the both end portions in the longitudinal direction, but an effect of reducing an influence of a water droplet is higher when the dielectric is formed on the both end portions.

For the dielectric 109 and the dielectric 110 as mentioned above, t1 representing a thickness of the dielectric that covers the conductor surface in FIG. 3 is desirably set to t1≥0.005λ. t1 is a thickness when the dielectrics 109 and 110 formed on the both end portions of the split ring portion 101 are formed on a surface on one side. The dielectric having the thickness t1 is also formed on a surface on an opposite side. Herein, λ is a vacuum wavelength of an electromagnetic wave at an operation frequency of the antenna 10. When it is assumed that the operation frequency is 1 to 6 GHz (wavelength 300 to 60 mm), 0.005λ is 1.5 to 0.3 mm.

Note that, as described above, an electric field having high intensity is generated near the split portion 104 and near the both end portions in the longitudinal direction (y-axis direction) of the split ring portion 101. Thus, the dielectrics 109 and 110 are formed in such a way as to extend not only immediately above the conductor of the split portion 104 and immediately above the conductor of the both end portions of the split ring portion 101 but also above the opening 107 in the direction toward the connection portion 102, above the dielectric substrate 106 in which the both end portions of the split ring portion 101 are extended in the y-axis direction, and above a space outside the dielectric substrate 106.

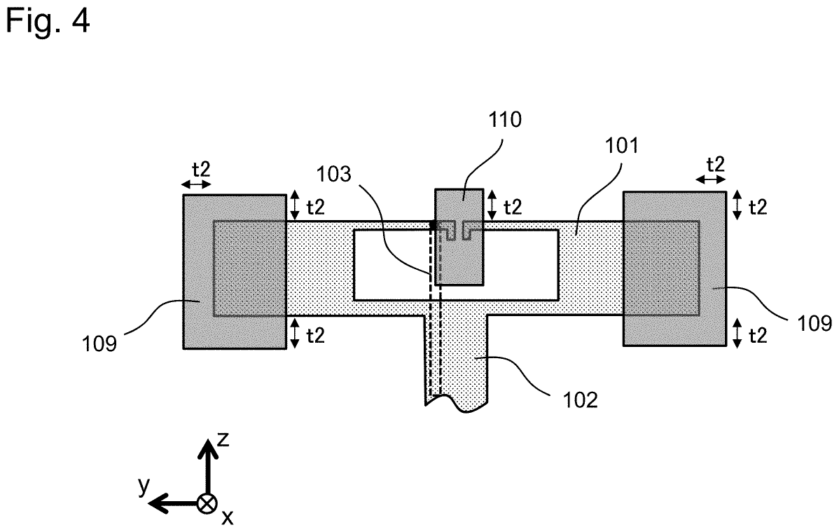

The thickness of the dielectric from the conductor surface is described above, but t2 indicating a distance between an upper end portion of the dielectric 109 and the dielectric 110 and an upper end portion of the split ring portion 101 and a distance between a lower end portion of the dielectric 109 and the dielectric 110 and a lower end portion of the split ring portion 101 when seen in the zy plane in FIG. 4 is more desirably set to t2≥0.005λ similarly to t1.

Note that, when the dielectrics 109 and 110 are made too thick, the antenna performance deteriorates due to a material loss. Thus, an upper limit of the thickness is, in a case of 1 to 6 GHz described above, about 50 to 10 mm, for example.

Further, in order to further suppress an influence of a water droplet, the surface of the dielectric 109 and the dielectric 110 may have water repellency.

Furthermore, when a relative dielectric constant of the dielectric 109 and the dielectric 110 is higher than that of the dielectric substrate 106, the nearby electromagnetic field radiation electromagnetic wave) is less likely to leak to the outside of the dielectrics 109 and 110, and thus an influence of a water droplet can be further suppressed.

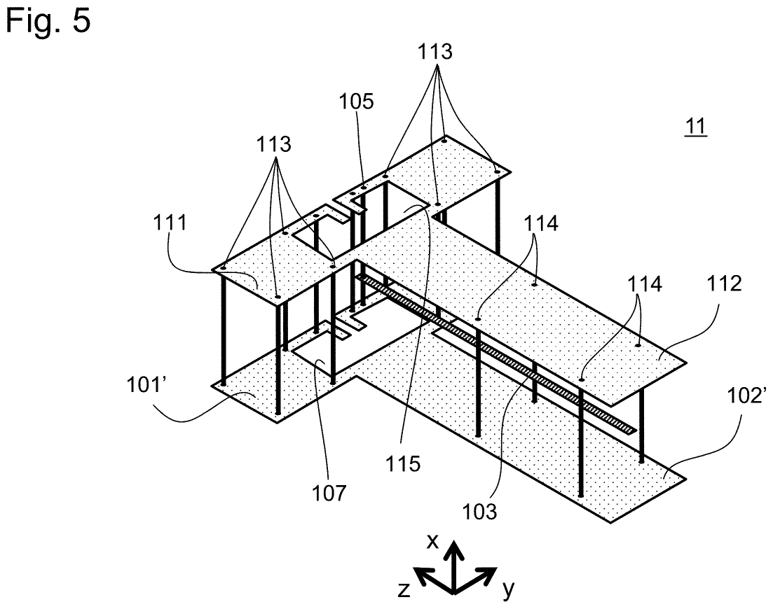

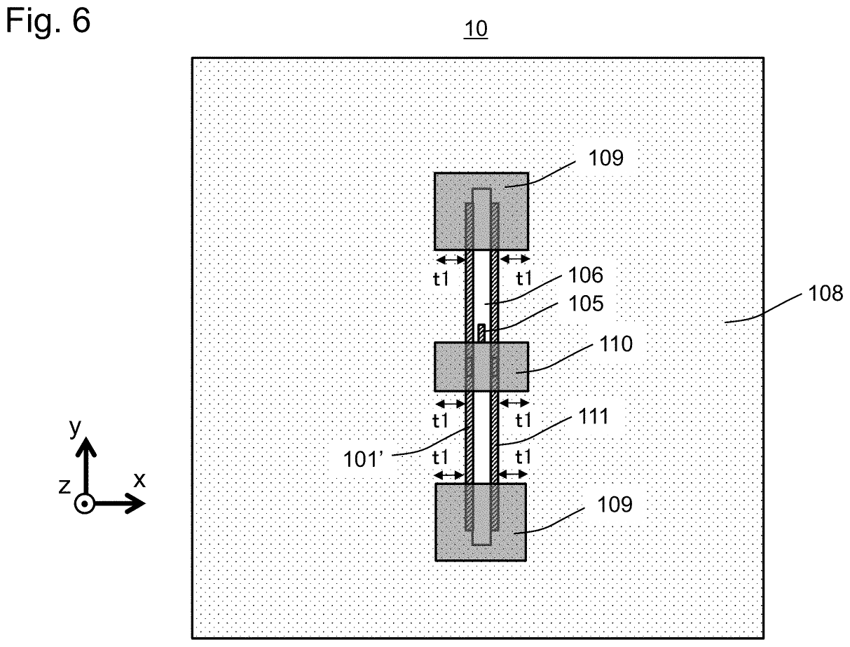

Hereinafter, a modification example of the first example embodiment will be indicated. FIGS. 5 and 6 are a perspective view and a top view each illustrating a modification example of the antenna element 11 according to the first example embodiment of the present invention. The dielectric substrate 106, the dielectric 109, and the dielectric 110 are omitted from FIG. 5 for simplification. The antenna element 11 in FIG. 5 further includes a second split ring portion 111 and a second connection portion 112 in a layer of the dielectric substrate 106 that is different from a layer in which a first split ring portion 101′ and a connection portion (first connection portion) 102′ are disposed and is different from a layer of the feeding line 103. Then, the feeding line 103 is configured in such a way as to be sandwiched between the first split ring portion 101′ and the first connection portion 102′ and the second split ring portion 111 and the second connection portion 112.

The second connection portion 112 is a conductor extending in the z-axis direction, includes one end connected to the vicinity of the center of a long side of the second split ring portion 111 on the side (z-axis negative direction side) closer to the reflection plate 108, and includes another end portion connected to the reflection plate 108. The second connection portion 112 electrically connects the second split ring portion 111 and the reflection plate 108. The first split ring portion 101′ and the second split ring portion 111 are electrically connected to each other with a plurality of conductor vias 113, and operate as one split ring resonator. Further, the first connection portion 102′ and the second connection portion 112 are electrically connected to each other with a plurality of conductor vias 114.

One end of the feeding line 103 is connected to a portion on the long side of the first split ring portion 101′ and the second split ring portion 111 on the side (z-axis positive direction side) farther from the reflection plate 108 via the conductor via 105. The feeding line 103 extends to a region facing the first connection portion 102′ and the second connection portion 112 across the opening 107 of the first split ring portion 101′ and an opening 115 of the second split ring portion 111 when seen from the y-axis direction.

The feeding line 103 is capacitively coupled to the first connection portion 102′ and the second connection portion 112, thereby forming a transmission line in the region facing the first connection portion 102′ and the second connection portion 112. As a result, an RF signal generated by the RF circuit, which is not illustrated, is transmitted by the feeding line 103 and fed to the first split ring portion 101′ and the second split ring portion 111.

With the configuration described above, the antenna element 11 in FIGS. 5 and 6 can confine, with the first connection portion 102′ and the second connection portion 112, an electromagnetic wave transmitted by the feeding line 103, and thus unnecessary radiation from the feeding line 103 can be reduced. Further, at this time, as illustrated in FIG. 6, a distance t1 from a surface of the split ring portion of the dielectric 109 and the dielectric 110 can be applied to each of the first split ring portion 101′ and the second split ring portion 111.

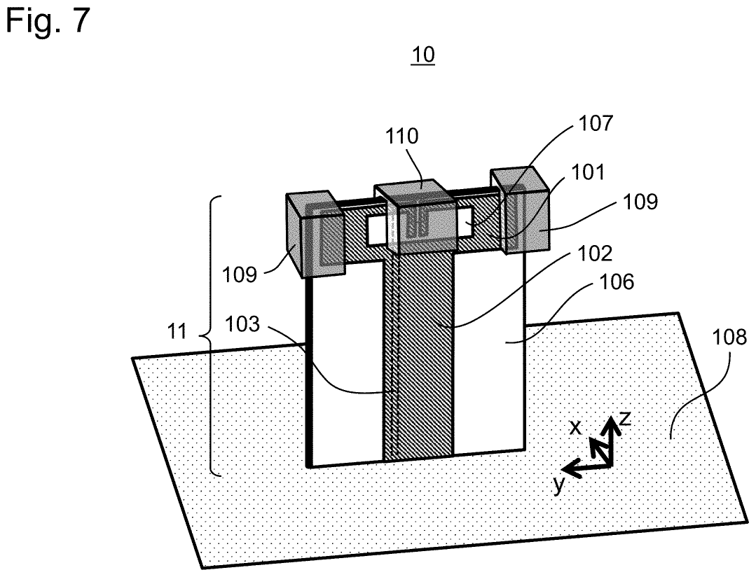

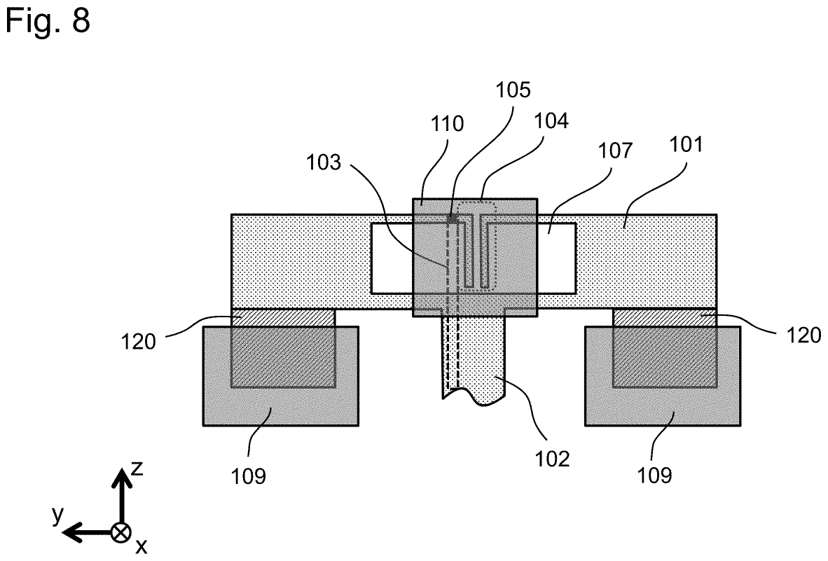

FIG. 7 is a perspective view illustrating a modification example of the antenna element 11. Further, FIG. 8 is a front view illustrating another modification example of the antenna element 11. The dielectric substrate 106 is omitted from FIG. 8 for simplification. In the example in FIGS. 7 and 8, a conductor facing in the split portion 104 extends to the vicinity of a connection point of the split ring portion 101 and the connection portion 102 in the z-axis negative direction, and, accordingly, the dielectric 110 also extends in the z-axis negative direction until covering an end portion in the z-axis positive direction of the connection portion 102. A reason for this is that the conductor facing in the split portion 104 extends, and thus a place having high electric field intensity spreads to the end portion in the z-axis direction negative direction of the split ring portion 101 and the end portion in the z-axis positive direction of the connection portion 102. Furthermore, the dielectric 110 also extends in the y-axis positive direction until overlapping the feeding line 103 when seen from the zy plane. A reason for this is that there is a possibility that a strong electric field may also be generated near the feeding line 103 depending on design of the split ring portion 101.

Furthermore, in FIG. 8, the antenna element 11 includes a radiation conductor 120 connected near the both end portions in the y-axis direction of the split ring portion 101. The radiation conductor 120 extends the split ring portion 101 in FIG. 8 in such a way as to bend, in the z-axis negative direction, the both end portions in the longitudinal direction (y-axis direction). With the present configuration, the antenna element 11 extends a current path through the conductor constituting the split ring portion 101, and an improvement in a radiation characteristic and a low frequency can be achieved. At this time, an electric field having relatively high intensity is generated near the radiation conductor 120 that is substantially the end portion in the longitudinal direction of the conductor continued to the split ring portion 101, and thus the dielectric 109 is desirably connected to the radiation conductor 120 as illustrated in FIG. 8.

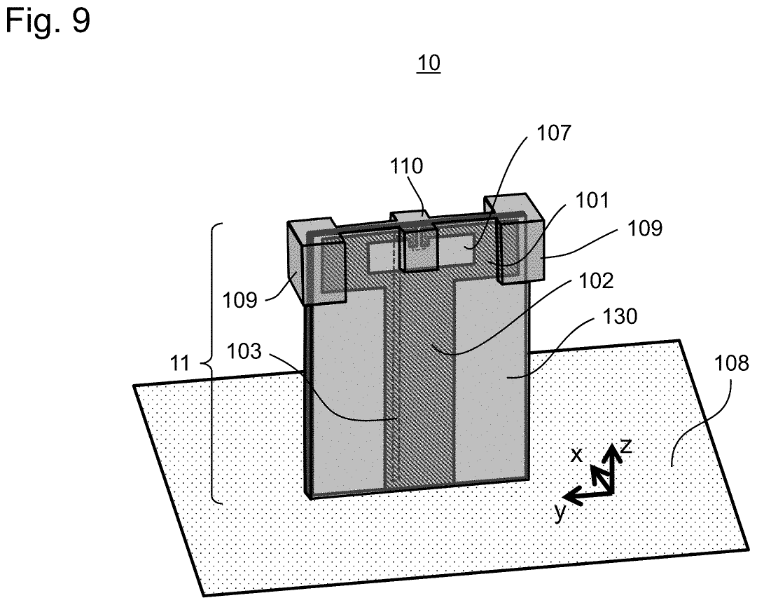

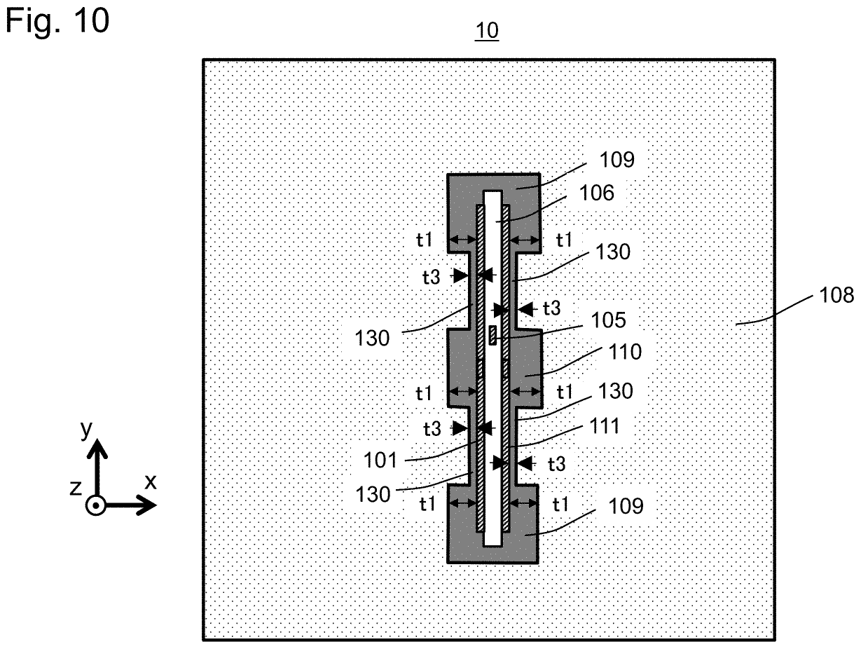

FIGS. 9 and 10 are a perspective view and a top view illustrating still another modification example of the antenna element 11. Note that it is assumed herein that the antenna element 11 in FIGS. 9 and 10 includes the second split ring portion 111 and the second connection portion 112 illustrated in FIGS. 5 and 6. The antenna element 11 in FIGS. 9 and 10 includes a dielectric 130 that covers a portion of the surface of the antenna element 11 having low electric field intensity except for near the split portion 104 and near the both end portions in the longitudinal direction (y-axis direction) of the split ring portions 101 and 111. The dielectric 130 is included for a purpose of preventing rust and dirt of the surface of the conductor and the dielectric of the antenna element 11 instead of suppressing deterioration of the antenna performance due to a water droplet. As mentioned above, when the dielectric that covers the antenna element 11 is too thick, deterioration of the antenna performance due to a material loss and difficulty of manufacturing occur, and thus a thickness t3 of the dielectric 130 illustrated in FIG. 10 is desirably thinner than t1 and t2.

Note that the dielectric 130 may be formed on the entire surface of the split ring portions 101, 101′ and 111, and the dielectrics 109 and 110 may be formed on the dielectric 130. In this case, a total thickness of the dielectric 130 and the dielectrics 109 and 110 may be equal to or more than 0.005λ in a place where the dielectrics 109 and 110 are formed.

### Second Example Embodiment

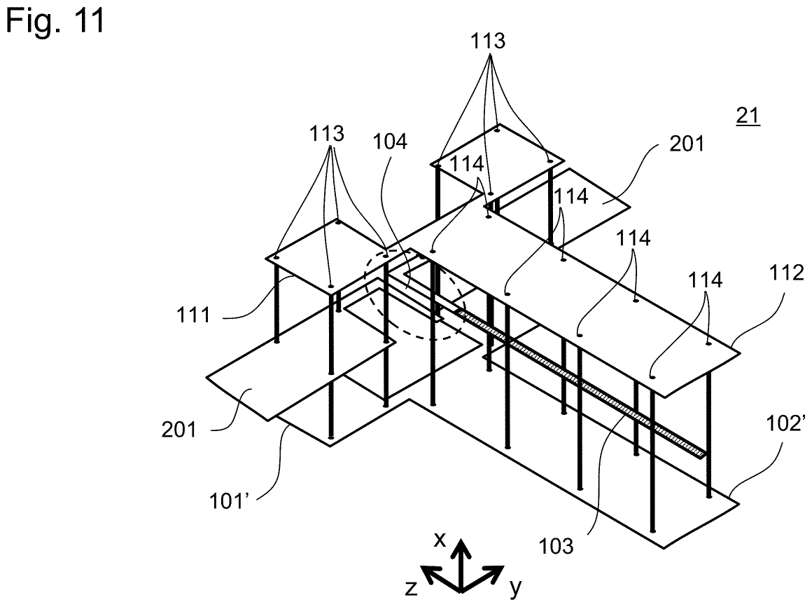

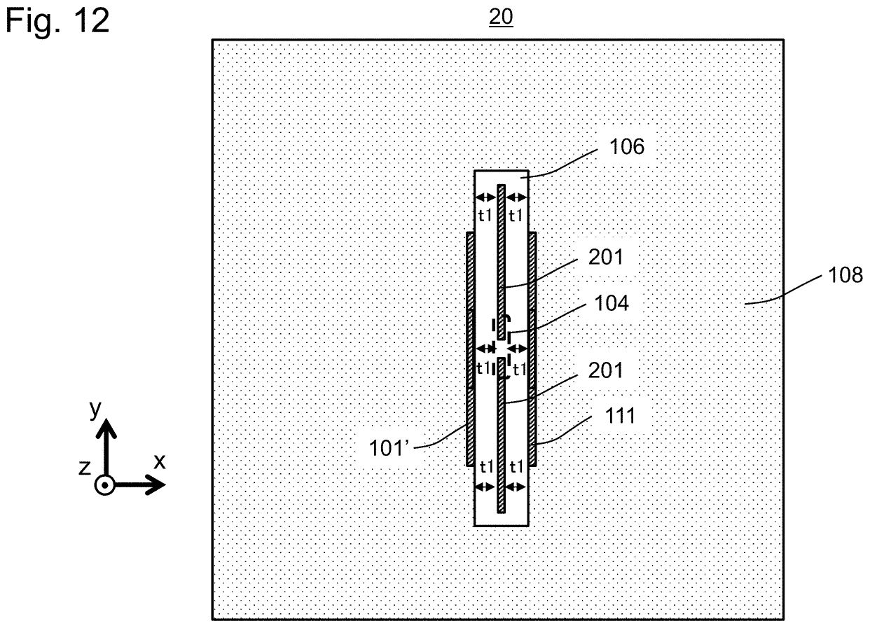

FIG. 11 is a perspective view of an antenna element 21 according to a second example embodiment of the present invention. FIG. 12 is a top view when an antenna 20 according to the second example embodiment is seen from the z-axis positive direction. Note that a dielectric substrate 106 is omitted from FIG. 11 for simplification. As illustrated in FIGS. 11 and 12, the antenna 20 according to the present example embodiment is similar to the configuration illustrated in FIGS. 5 and 6 in the first example embodiment except for the following point. The same configuration as that of an antenna 10 according to a first example embodiment has the same reference sign, and detailed description thereof is omitted.

In the configuration illustrated in FIGS. 11 and 12, a first split ring portion 101′ and a second split ring portion 111 have a structure acquired by removing a long side portion on the z-axis positive direction side including a split ring portion 104 from the configuration illustrated in FIGS. 5 and 6. The antenna element 21 further includes a third split ring portion 201 in the same layer of the dielectric substrate 106 as a feeding line 103. The third split ring portion 201 has a structure acquired by removing long side portions facing across the split ring portion 104 and an opening 107 from a split ring portion 101 in the first example embodiment. Further, a length in the longitudinal direction (y-axis direction) of the third split ring portion 201 is set longer than a length in the longitudinal direction of the first split ring portion 101′ and the second split ring portion 111. A plurality of conductor vias 113 electrically connect the first split ring portion 101′, the second split ring portion 111, and the third split ring portion 201. The feeding line 103 is directly connected to the third split ring portion 201, and a conductor via 105 is unnecessary. Note that, in FIG. 11, the feeding line 103 is connected to one of tip portions of the conductor facing in the split portion 104, but may be connected to an end portion in the z-axis positive direction of the third split ring portion 201 through the opening. Further, the antenna element 21 does not include dielectrics 109 and 110.

With the above-mentioned configuration illustrated in FIGS. 11 and 12, the first split ring portion 101′, the second split ring portion 111, and the third split ring portion 201 are connected with the conductor via 113 in the antenna element 21 according to the second example embodiment. Thus, the conductors in the three layers constitute one split ring resonator and operate as an antenna. A split portion is included in the third split ring portion 201, and a current flowing in a ring shape through the opening portion flows back and forth through the three split ring portions via the conductor via 113.

As mentioned above, in the present example embodiment, a length in the longitudinal direction of the third split ring portion 201 is set longer than a length in the longitudinal direction of the first split ring portion 101′ and the second split ring portion 111. Then, the end portion in the longitudinal direction of the third split ring portion 201 is an end portion in the longitudinal direction of the entire split ring. Since the third split ring portion 201 is an inner layer, the dielectric substrates located above and below the third split ring portion 201 can thickly cover the end portion in the longitudinal direction of the split ring. In other words, the end portion in the longitudinal direction of the split ring can be automatically thickly covered with a thickness of the dielectric substrates. Thus, deterioration of the antenna performance due to adhesion of a water droplet can be suppressed by using a thickness of the dielectric substrates without forming the dielectric 109 and the dielectric 110 as in the first example embodiment. As illustrated in FIGS. 11 and 12, both end portions in the longitudinal direction (y-axis direction) of the split portion 104 and the split ring resonator that are a place having high electric field intensity in the antenna element 21 are both included in the third split ring portion 201 that is an inner layer of the dielectric substrate 106. Thus, the conductor surfaces having high electric field intensity are covered with the dielectric substrate 106 (dielectric constituting the dielectric substrate 106) instead of the dielectric 109 and the dielectric 110, and, as a result, deterioration of the antenna performance due to adhesion of a water droplet can be suppressed. The configuration does not need the dielectric 109 and the dielectric 110, and thus the antenna element 21 can be more simply formed. Note that, at this time, a thickness t1 of the dielectric connected to the conductor surface having high electric field intensity corresponds to a half of a thickness in the x-axis direction of the dielectric substrate 106 except for a thickness of a conductor layer. Thus, the thickness in the x-axis direction of the dielectric substrate 106 except for the thickness of the conductor layer is desirably equal to or more than 0.01λ that is twice 0.005λ.

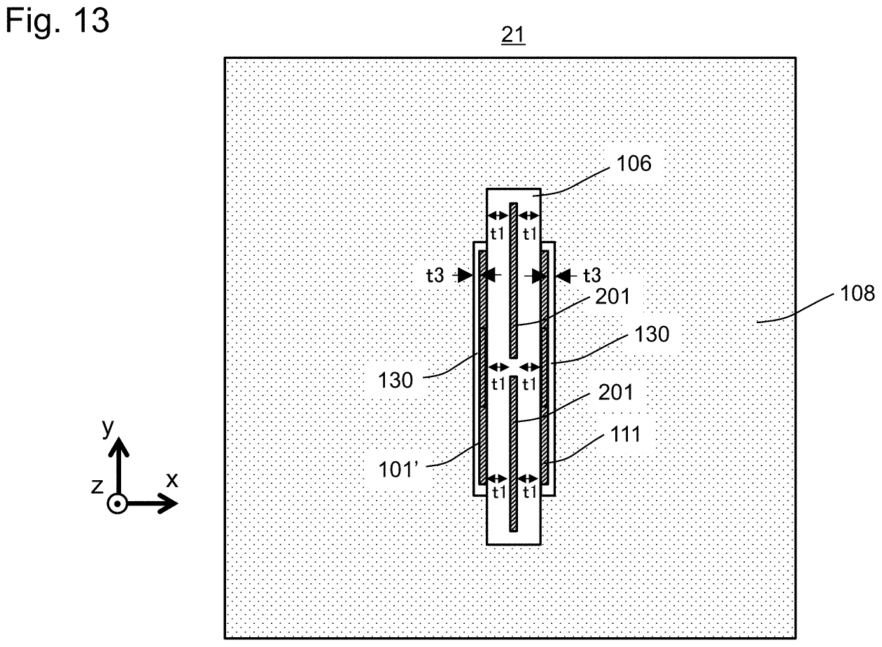

Note that, as illustrated in a top view in FIG. 13, the antenna element 21 may include a dielectric 130 in FIGS. 9 and 10 indicated in the first example embodiment.

Further, in FIGS. 11 and 12, the first split ring portion 101′, the second split ring portion 111, and the third split ring portion 201 are included in the three different layers of the dielectric substrate 106, but a split ring resonator may be formed in four or more conductor layers with a configuration including more layers. Also, in this case, the conductor surface of the both end portions in the longitudinal direction (y-axis direction) of the split portion 104 and the split ring resonator having high electric field intensity may be covered with the dielectric substrate 106.

### Third Example Embodiment

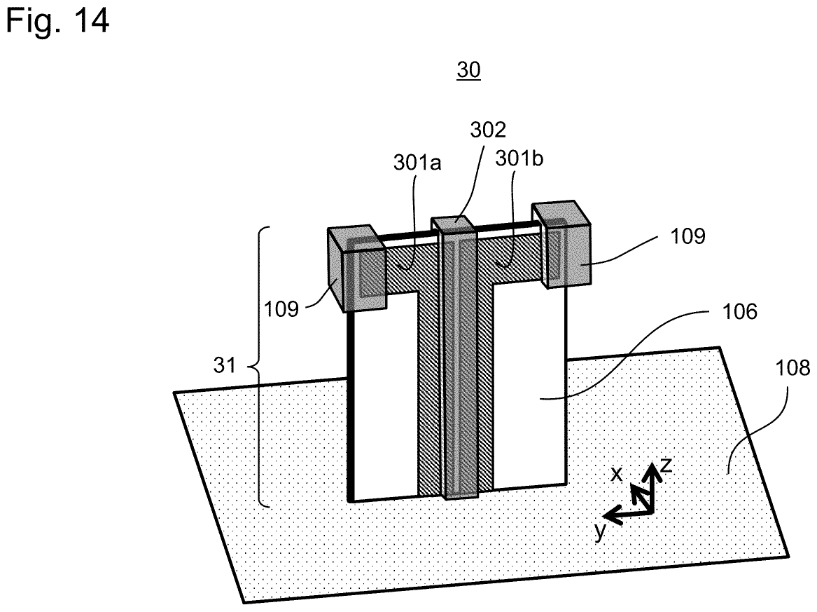

FIG. 14 is a perspective view of an antenna 30 according to a third example embodiment of the present invention. The antenna 30 according to the present example embodiment includes an antenna element 31 that is a dipole antenna. The same configuration as that of an antenna 10 according to a first example embodiment has the same reference sign, and detailed description thereof is omitted.

As illustrated in FIG. 14, the antenna element 31 includes a conductor pattern 301a and a conductor pattern 301b that are conductor patterns formed in a substantially L shape on a surface of a dielectric substrate 106. The conductor pattern 301a and the conductor pattern 301b form the dipole antenna, include an end portion in the z-axis negative direction being connected to an RF circuit, which is not illustrated, with a signal line, and perform transmission and reception of an RF signal. Further, the antenna element 31 includes a dielectric 109 and a dielectric 302. Similarly to the first example embodiment, the dielectric 109 is connected to both end portions in the y-axis direction of the conductor pattern 301a and the conductor pattern 301b in such a way as to cover a conductor surface of the portions. Thus, when the antenna element 31 operates as the dipole antenna, the dielectric 109 can prevent a water droplet from directly adhering to both end portions of a dipole antenna conductor that is a place having high electric field intensity, i.e., the both end portions in the y-axis direction of the conductor pattern 301a and the conductor pattern 301b, and can suppress deterioration of the antenna performance due to adhesion of the water droplet. Furthermore, the dielectric 302 is connected, in such a way as to cover a conductor surface of the portion, to the vicinity of the center in the y-axis direction of the dielectric substrate 106 where the conductor pattern 301a and the conductor pattern 301b face each other at a short distance. Thus, the dielectric 302 can prevent a water droplet from directly adhering to the place where conductors are brought close to each other, electric field intensity increases, and the conductor pattern 301a and the conductor pattern 301b face each other, and can suppress deterioration of the antenna performance due to adhesion of the water droplet. Note that a thickness of the dielectric 109 and the dielectric 302 from the surface of the conductor pattern 301a and the conductor pattern 301b in the x-axis direction is desirably equal to or more than 0.005λ similarly to the first example embodiment.

### Fourth Example Embodiment

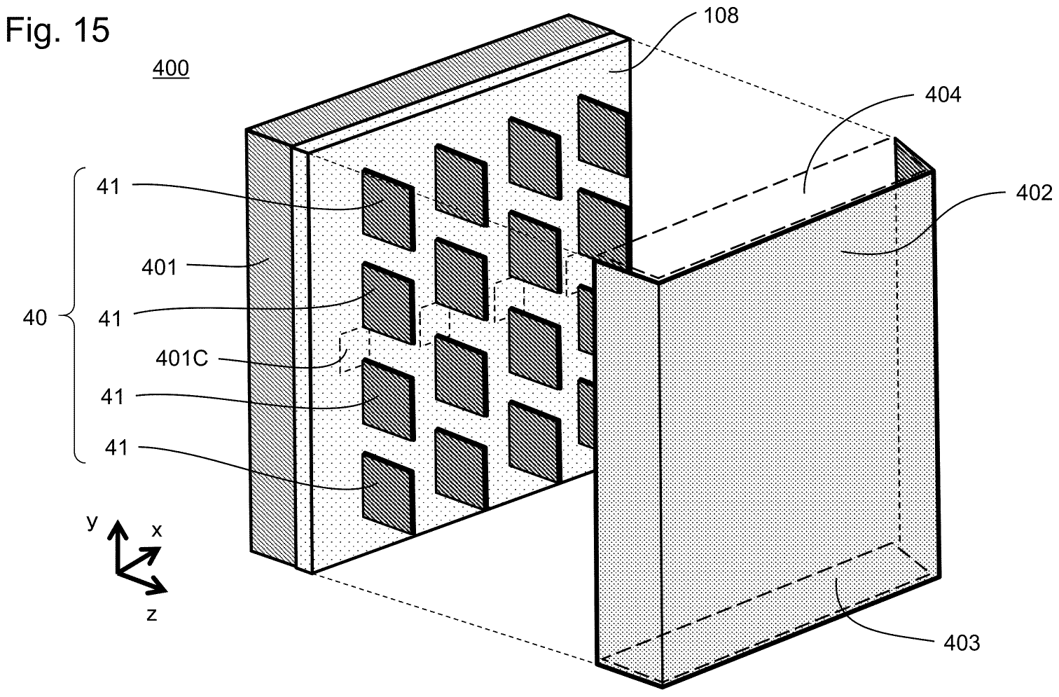

A fourth example embodiment of the present invention will be described by using FIGS. 15 to 21. The same configuration as that of an antenna 10 according to a first example embodiment has the same reference sign, and detailed description thereof is omitted.

FIG. 15 is a schematic perspective view of a wireless communication device 400 according to the present example embodiment. The wireless communication device 400 includes a casing portion 401 having a box shape, a reflection plate 108 integrally attached to the casing portion 401, an array antenna 40 including a plurality of antenna elements 41 provided on the reflection plate 108, and a radome 402 that covers the array antenna 40. FIG. 15 illustrates that the reflection plate 108 and the radome 402 are separated from an assembly state in order to facilitate understanding.

A communication circuit 401C is built in the casing portion 401. The communication circuit 401C is electrically connected to the array antenna 40. In this way, a wireless signal generated by the communication circuit 401C is radiated as an electromagnetic wave into an atmosphere via the array antenna 40, and is transmitted to and received from another facility (for example, a wireless terminal, or the like).

The plurality of antenna elements 41 are arranged on the reflection plate 108 in a lattice pattern with an interval between each other, and constitute the array antenna 40. The antenna element 41 is an antenna element 11, 21, or 31 according to the first, second, and third example embodiment. For example, the array antenna 40 can form a beam directed in a specific direction by changing a phase and power of a signal for each of the antenna elements 41.

As illustrated in FIG. 15, the radome 402 is a member that covers the array antenna 40. More specifically, the radome 402 is bent in a substantially C shape when seen from the y-axis direction. End edges on both sides in the x direction of the radome 402 are each fixed to a side extending in the y-axis direction in the casing portion 401 described above. In this way, in a state where the radome 402 is fixed to the casing portion 401, a space as a ventilation flow path is formed between the radome 402 and the reflection plate 108. The plurality of antenna elements 41 provided on the reflection plate 108 are housed in the space.

Furthermore, both sides in the y-axis direction of the space are each open toward an outside. Between the openings, an opening facing vertically downward (y-axis negative direction) is an intake hole 403, and an opening facing vertically upward (y-axis positive direction) is an exhaust hole 404. In other words, the ventilation flow path described above communicates with the outside via the intake hole 403 and the exhaust hole 404.

Note that the radome 402 is desirably formed of a material having an insulating property in such a way as not to shield a signal radiated from the antenna element 41 described above.

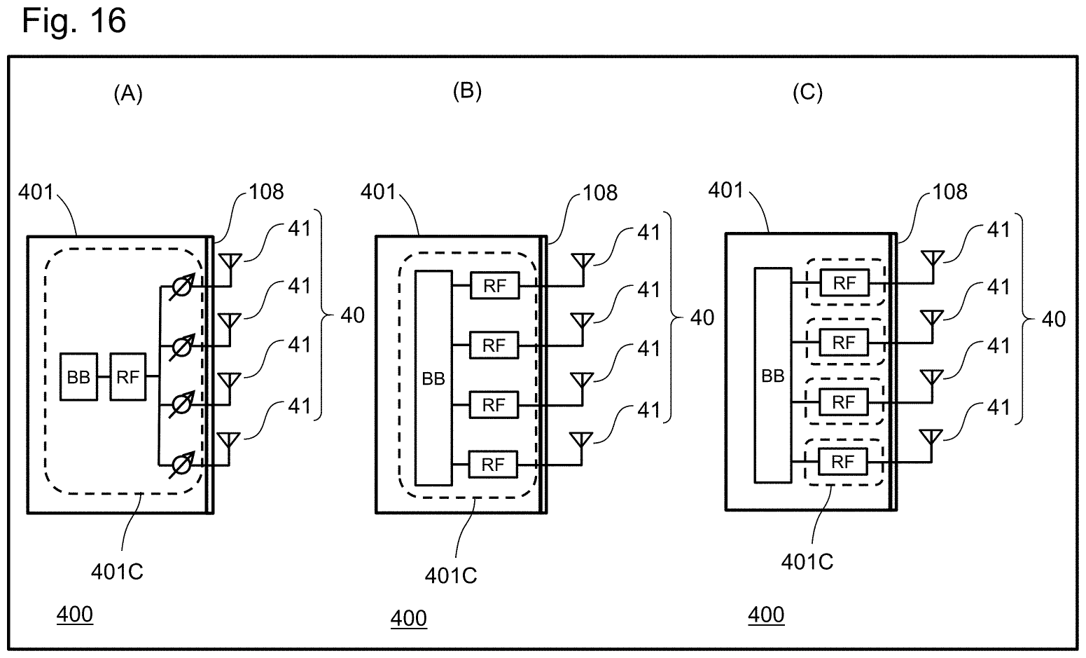

FIG. 16 is a diagram schematically illustrating one example of a circuit configuration of the wireless communication device 400. In the wireless communication device 400 in (A) of FIG. 16, one communication circuit 401C is configured to include a phase shifter, a wireless circuit (RF), and a base band circuit (BB). However, one phase shifter is included in each of the antenna elements 41. Such a configuration can change a phase for each antenna element 41, and thus a beam direction can be controlled.

Further, another example of a device configuration of the wireless communication device 400 is illustrated in (B) of FIG. 16. In the wireless communication device 400 in (B) of FIG. 16, one communication circuit 401C is configured to include a wireless circuit (RF) and a base band circuit (BB). However, one wireless circuit is included in each of the antenna elements 41. With such a configuration, the wireless communication device 400 can also comply with spatial multiplex communication that transmits and receives a wireless signal different for each antenna element 41.

Further, still another example of a device configuration of the wireless communication device 400 is illustrated in (C) of FIG. 16. In the wireless communication device 400 in (C) of FIG. 16, each of the plurality of communication circuits 401C is configured to include one wireless circuit (RF). In other words, one communication circuit 401C is included in each of the antenna elements 41. With such a configuration, the wireless communication device 400 can also comply with spatial multiplex communication that transmits and receives a wireless signal different for each antenna element 41. However, the device configuration of the wireless communication device 400 is not limited to that in (A), (B), and (C) of FIG. 16. For example, the communication circuit 401C in (A) and (B) of FIG. 16 may be configured not to include the base band circuit (BB). Further, the base band circuit (BB) may be configured in such a way as to be disposed outside the wireless communication device 400, and another configuration may be used.

In any of the device configurations, the communication circuit 401C generates heat according to transmission and reception of a wireless signal, and thus there is a possibility that an operation of the communication circuit 401C itself may be influenced.

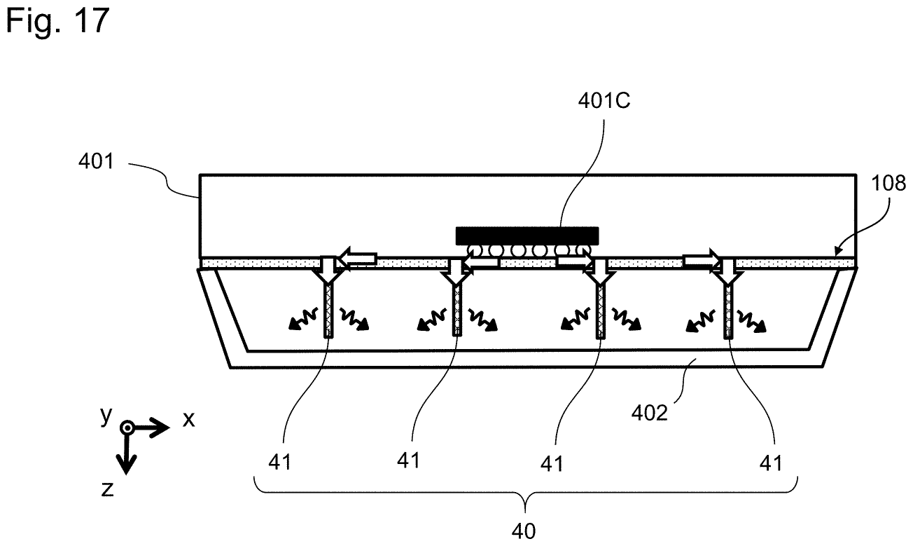

Herein, a heat radiation path of heat generated in the communication circuit 401C is illustrated in FIG. 17. The communication circuit 401C is connected to the reflection plate 108 with a member having a high heat conductive property, and a part of generated heat is conducted to the reflection plate 108. As the member having a high heat conductive property, for example, a ball grid array (BGA), a solder ball, a solder ball around which a heat conductive underfill fills, or the like can be used. Furthermore, the heat is conducted from the reflection plate 108 to the plurality of antenna elements 41, and the heat is transferred from each of the antenna elements 41 to the air. The air that receives the heat from the antenna element 41 is guided to the outside along the ventilation flow path formed by the radome 402 described above, and thus the heat is radiated to the outside. An arrow in FIG. 17 indicates a heat radiation direction.

As described above, the antenna element 41 functions as a heat radiation fin. With the present configuration, the wireless communication device 400 can efficiently radiate heat generated in the communication circuit 410C via the array antenna 40.

Further, herein, when the wireless communication device 400 is installed outside, the radome 402 includes the intake hole 403 and the exhaust hole 404, and thus there is a possibility that a water droplet may adhere to the antenna element 41 in rainy weather. Further, a case where dirt, dust, or the like adhere to the antenna element 41 is also conceivable. At this time, deterioration of the antenna performance can be suppressed by using, for example, the antenna element 11, 21, or 31 according to the first, second, and third example embodiment as the antenna element 41. Note that the thickness t1 of the dielectric that covers the conductor surface having high electric field intensity illustrated in FIGS. 3, 6, 10, 12, and 13 is more desirably equal to or less than about 2 mm in consideration of heat conductive performance from the above-mentioned antenna element 41 to the surrounding air.

Further, when a dielectric that covers a portion other than the portion having high electric field intensity is included, a thickness t3 thereof is also similarly as thin as possible due to heat transmission performance to the surrounding air, and is desirably equal to or less than 0.1 mm, for example.

Hereinafter, a modification example of the fourth example embodiment will be indicated. In FIG. 15, the wireless communication device 400 includes the radome 402, but may not include the radome 402 within an acceptable limit of an environment in which a wireless communication device is disposed. For example, since there is no influence of wind and rain when the wireless communication device 400 is installed inside, the radome 402 may often be omitted. Further, the radome 402 in FIG. 15 includes the intake hole 403 and the exhaust hole 404 each on both sides in the y-axis direction, but the intake hole and the exhaust hole may also be included on both sides in the x-axis direction and in the z-axis positive direction.

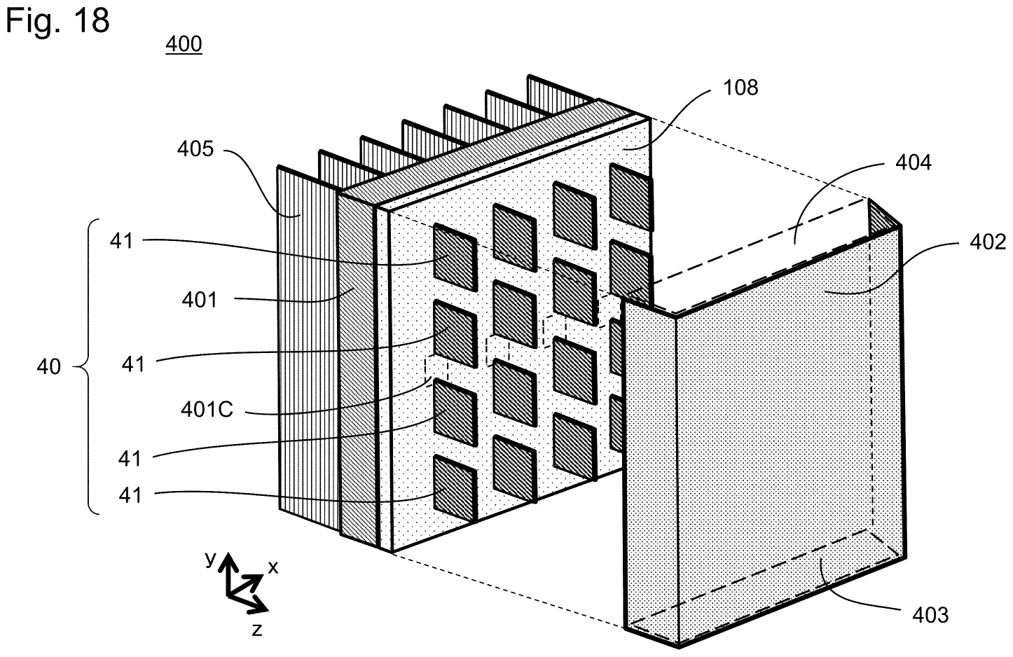

Further, as illustrated in FIG. 18, the wireless communication device 400 may include a heat radiator 405 (heat sink) on a side opposite to the array antenna 40 side of the casing portion 401. Such a configuration further improves heat radiation performance of the wireless communication device 400. Note that, for example, a configuration that simply roughens a rear surface of the casing portion 401 and increases a heat radiation area or a configuration (phase change cooling method) that uses a phase change in a heat medium, which is not limited to a configuration including a plurality of heat radiation fins as in the illustrated example, can be applied to the heat radiator 405.

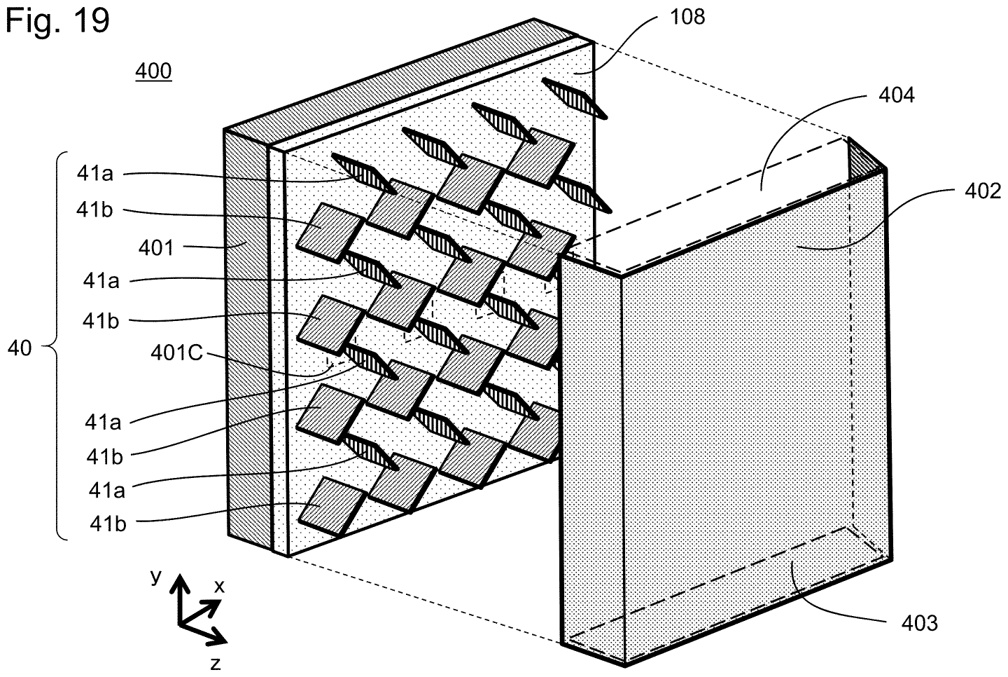

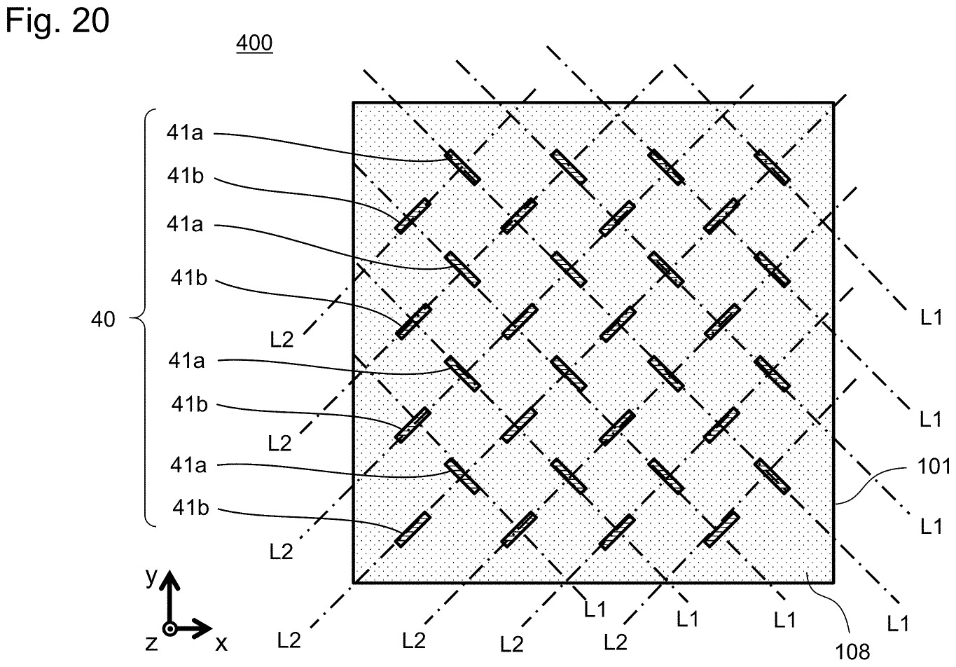

FIGS. 19 and 20 are a schematic perspective view and a schematic plan view illustrating a modification example of the wireless communication device 400. The wireless communication device 400 illustrated in FIGS. 19 and 20 includes the antenna element 41 disposed at an angle with respect to the y-axis direction. Furthermore, in FIGS. 19 and 20, the array antenna 40 includes a first element group L1 including a plurality of first antenna elements 41a and a second element group L2 including a plurality of second antenna elements 41b. The first antenna element 41a in the first element group L1 extends in a first direction inclined only approximately 45° toward the y-axis direction within the yz plane on the reflection plate 108. On the other hand, the second antenna element 41b in the second element group L2 is inclined in a direction (second direction) approximately orthogonal to the first direction described above within the yz plane. Then, a plurality of the first element groups L1 are arranged in the second direction with an interval on the reflection plate 108, and a plurality of the second element groups L2 are arranged in the first direction with an interval.

The plurality of first antenna elements 41a and the plurality of second antenna elements 41b are arranged in a square lattice pattern at the same pitch from each other. In other words, when seen from a normal direction (z direction) of the reflection plate 108, all dimensions between the first antenna elements 41a adjacent to each other are approximately equal. Similarly, all dimensions between the second antenna elements 41b adjacent to each other are also approximately equal.

Each of the first antenna elements 41a is disposed between a pair of the second antenna elements 41b adjacent to each other in the second direction. Furthermore, when seen from the normal direction of the reflection plate 108, a line connecting the pair of the adjacent second antenna elements 41b is configured in such a way as to pass through the center of the first antenna element 41a in the first direction. Herein, since the second antenna elements 41b are also arranged in a square lattice pattern as described above, a line connecting a pair of the adjacent first antenna elements 41a passes through the center of the second antenna element 41b in the first direction. Note that the “center” described above does not necessarily need to be strict, and a region that divides equally the first antenna elements 41a or the second antenna elements 41b may be substantially passed.

As described above, since the first element group L1 and the second element group L2 are arranged in the directions orthogonal to each other, respective polarized waves are also in a state of orthogonal to each other. Furthermore, the plurality of first element groups L1 and second element groups L2 are each separately controlled by the communication circuit 401C. In other words, wireless signals having different phases and power are each supplied to the first element group L1 and the second element group L2. In this way, the first element group L1 and the second element group L2 described above form array antennas independent of each other. In other words, the array antenna 40 including the first element group L1 and the second element group L2 operates as a polarized wave sharing array antenna that can form a different beam for each polarized wave. Furthermore, the first element group L1 and the second element group L2 are arranged as described above, and thus a possibility that regions having high intensity of an electric field and a magnetic field formed by signal radiation from the first antenna element 41a and the second antenna element 41b overlap each other can be reduced. In this way, the first antenna element 41a and the second antenna element 41b can be disposed close to each other while suppressing electromagnetic coupling therebetween. In addition, according to the configuration as described above, a gap formed by the first antenna element 41a and the second antenna element 41b is in a state of meandering in a zigzag pattern along the y-axis. In this way, the air flowing by natural convection in the ventilation flow path sufficiently contacts the first antenna element 41a and the second antenna element 41b, and thus the heat radiation performance of the wireless communication device 400 further improves.

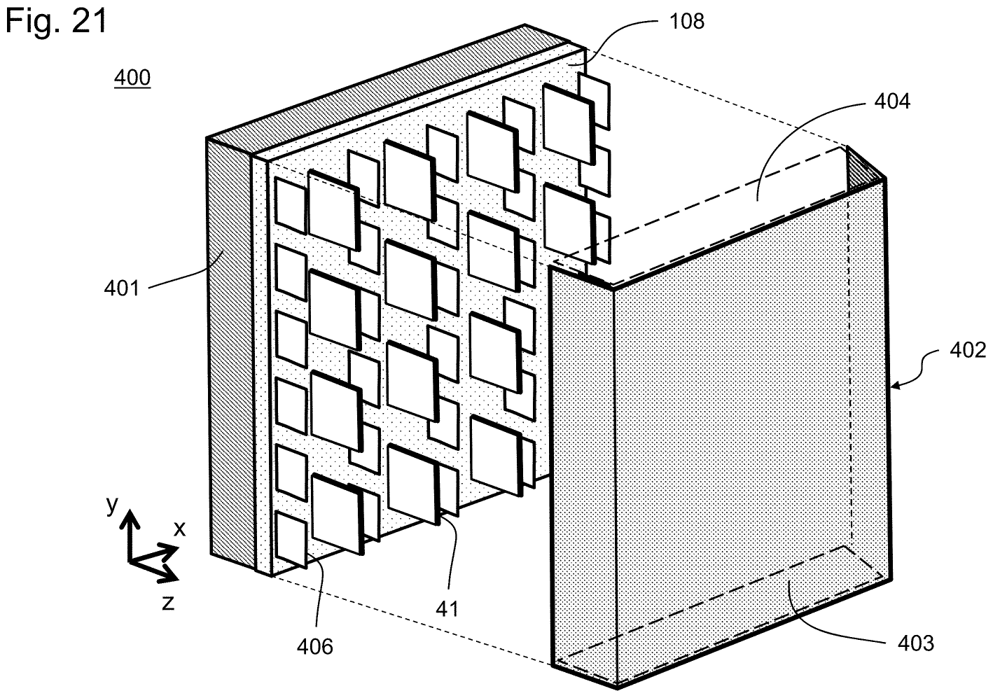

FIG. 21 is a schematic perspective view illustrating a modification example of the wireless communication device 400. The wireless communication device 400 includes, as a heat radiation fin on the reflection plate, a heat radiation fin 406 other than the antenna. The heat radiation fin 406 does not have an influence on performance of the antenna and increases heat transfer to the air, and thus the heat radiation fin 406 is formed of a dielectric having a high heat conductivity and a frequency selective sheet/surface (FSS), for example. FSS has a structure that is formed of a metal pattern and transmits/reflects only an electromagnetic wave at a specific frequency. An influence on the antenna can be suppressed by radio wave transmission, and a heat conductivity can be improved by formation with metal.

Note that the example embodiments and the plurality of modification examples mentioned above can be, of course, combined within an extent that a content thereof is not inconsistent. Further, in the example embodiments and the modification examples mentioned above, a function and the like of each component is specifically described, but various modifications can be made to the function and the like within an extent that the invention of the present application is satisfied.

For example, the dielectrics 109 and 110 in the first to fourth example embodiments are all formed on both sides of the conductor portion. An effect is further increased with both sides than one side in order to suppress deterioration of the antenna characteristic. However, when a water droplet is likely to adhere to only one side and not to the other side, the dielectrics 109 and 110 may be formed only on the one side.

### Fifth Example Embodiment

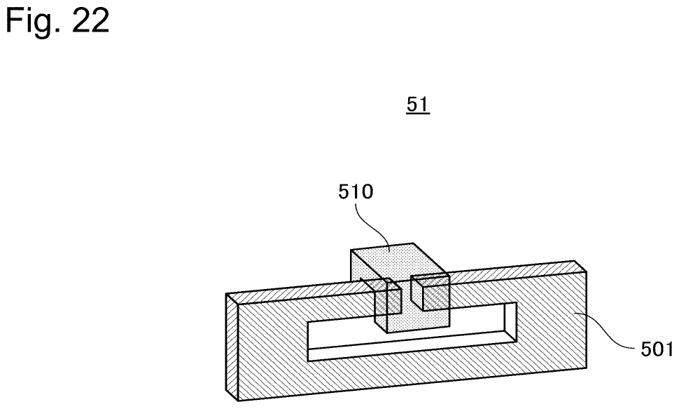

FIG. 22 is a schematic perspective view illustrating an antenna element 51 according to a fifth example embodiment of the present invention. The antenna element according to the present example embodiment includes a conductor portion 501, and a first dielectric 510 having a thickness equal to or more than 0.005λ when a vacuum wavelength of an electromagnetic wave at an operation frequency of an antenna is λ is formed in a place of a surface of the conductor portion 501 having higher electric field intensity during operation than that of another place.

A nearby electromagnetic field remaining in the antenna and near a periphery of the antenna is greatly attenuated in proportion to a distance from the center of the antenna. Thus, an influence of a water droplet greatly changes depending on whether the water droplet adheres to a surface of the first dielectric 510 or to the surface of the conductor portion 501. Accordingly, even when a water droplet adheres to the surface of the first dielectric 510, an influence of the water droplet on the nearby electromagnetic field can be suppressed as compared to a case where the water droplet directly adheres to the surface of the conductor portion 501, and deterioration of the antenna characteristic such as a resonance frequency can be suppressed.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

The whole or part of the example embodiments disclosed above can be described as, but not limited to, the following supplementary notes.

### (Supplementary Note 1)

An antenna element comprising:

a conductor portion; and

a first dielectric having a thickness equal to or more than 0.005λ when a vacuum wavelength of an electromagnetic wave at an operation frequency of an antenna is λ, and formed in a place of a surface of the conductor portion having higher electric field intensity during operation than that of another place.

### (Supplementary Note 2)

The antenna element according to supplementary note 1, wherein the first dielectric is formed only in a place of a surface of the conductor portion having higher electric field intensity during operation than that of another place.

### (Supplementary Note 3)

The antenna element according to supplementary note 1 or 2, further comprising

a second dielectric formed on a surface of the conductor portion except for a place having higher electric field intensity during the operation than that of another place, and having a thickness thinner than that of the first dielectric.

### (Supplementary Note 4)

An antenna comprising: the antenna element according to any one of supplementary notes 1 to 3; and a reflection plate disposed at an interval with the antenna element, wherein

the conductor portion is a split ring conductor having a shape in which a part of a ring is cut by a split portion,

the first dielectric is connected in such a way as to cover at least a split portion of the split ring conductor and a surface of both end portions in a longitudinal direction of the split ring conductor,

the antenna element further includes
a connection conductor including one end electrically connected to the split ring conductor, and another end portion electrically connected to the reflection plate, and
a feeding line including one end electrically connected to the split ring conductor, and

the feeding line overlaps a region of the connection conductor surrounded by an outer edge across an opening formed in the split ring conductor.

### (Supplementary Note 5)

The antenna according to supplementary note 4, wherein

both ends of the split ring conductor sandwiching the split portion are extended toward the connection conductor side, and the first dielectric is formed on a surface of the extended conductor.

### (Supplementary Note 6)

The antenna according to supplementary note 4 or 5, wherein

a shape of the split ring conductor is a shape having a plurality of longitudinal sides in a direction parallel to a surface of the reflection plate on a side on which the antenna element is disposed,

the split portion is provided in a vicinity of a center of a first longitudinal side of the split ring conductor, and

the connection conductor is electrically connected to a vicinity of a center of a second longitudinal side of the split ring conductor.

### (Supplementary Note 7)

The antenna according to any one of supplementary notes 4 to 6, wherein

the first dielectric is formed only on the split portion.

### (Supplementary Note 8)

The antenna according to any one of supplementary notes 4 to 6, wherein

the first dielectric is formed only on the split portion and one end portion in a longitudinal direction of the split ring conductor.

### (Supplementary Note 9)

The antenna according to any one of supplementary notes 4 to 6, wherein

the first dielectric is formed only on the split portion and both end portions in a longitudinal direction of the split ring conductor.

### (Supplementary Note 10)

The antenna according to any one of supplementary notes 4 to 9, wherein

at least the split ring conductor, the connection conductor, and the feeding line are disposed in a layer provided on a dielectric substrate.

### (Supplementary Note 11)

The antenna according to supplementary note 10, further comprising:

at least one of a second split ring conductor and a second connection conductor in a layer of the dielectric substrate different from a layer in which the split ring conductor and the connection conductor are disposed; and

at least either of a plurality of conductor vias that electrically connect the split ring conductor and the second split ring conductor, and a plurality of conductor vias that electrically connect the connection conductor and the second connection conductor.

### (Supplementary Note 12)

The antenna according to supplementary note 11, further comprising

a plurality of the split ring conductors electrically connected with the plurality of conductor vias and disposed in a different layer of the dielectric substrate, wherein

only a split ring conductor disposed in an inner layer of the dielectric substrate among the split ring conductors includes a conductor portion that faces in a vicinity in the split portion, and, furthermore, a length in a longitudinal direction of a split ring conductor disposed in a layer of a surface of the dielectric substrate is shorter than a length in a longitudinal direction of a split ring conductor disposed in an inner layer.

### (Supplementary Note 13)

The antenna according to any one of supplementary notes 1 to 3, wherein

the antenna element is a dipole antenna element, and the first dielectric is formed in a place where two conductors constituting the dipole antenna element face each other and a tip of each of the two conductors.

### (Supplementary Note 14)

An antenna comprising the antenna element according to any one of claims 1 to 13, wherein

a thickness of the first dielectric is equal to or less than 2 mm.

### (Supplementary Note 15)

The antenna element according to any one of supplementary notes 1 to 3, wherein

a surface of the first dielectric has water repellency.

### (Supplementary Note 16)

An array antenna comprising the antenna element according to any one of supplementary notes 4 to 15, wherein

a plurality of the antenna elements are arranged in a one-dimensional or two-dimensional array pattern on the reflection plate.

### (Supplementary Note 17)

A wireless communication device comprising at least one of the antenna according to any one of claims 1 to 16.

### (Supplementary Note 18)

The wireless communication device according to supplementary note 17, further comprising:

a radome that forms a ventilation flow path between the reflection plate and the radome, and includes an intake hole and an exhaust hole that communicate with the ventilation flow path; and

a communication circuit that excites the array antenna, and also transmits and receives a wireless signal via the array antenna.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

This application is based upon and claims the benefit of priority from Japanese patent application No. 2018-94384, filed on May 16, 2018, the disclosure of which is incorporated herein in its entirety by reference.

### REFERENCE SIGNS LIST

10, 20, 30 Antenna
11, 21, 31 Antenna element
40 Array antenna
41a First antenna element
41b Second antenna element
101 Split ring portion
102 Connection portion
102′ First connection portion
103 Feeding line
104 Split portion
105, 113, 114 Conductor via
106 Dielectric substrate
107 Opening
108 Reflection plate
109, 110, 130, 302 Dielectric
101′ First split ring portion
111 Second split ring portion
112 Second connection portion
120 Radiation conductor
201 Third split ring portion
301a, 301b Conductor pattern
400 Wireless communication device
401 Casing portion
401C Communication circuit
402 Radome
405 Heat radiator

1. An antenna element comprising:
a conductor portion; and
a first dielectric having a thickness equal to or more than 0.005λ when a vacuum wavelength of an electromagnetic wave at an operation frequency of an antenna is λ, and formed in a place of a surface of the conductor portion having higher electric field intensity during operation than that of another place.

2. The antenna element according to claim 1, wherein
the first dielectric is formed only in a place of a surface of the conductor portion having higher electric field intensity during operation than that of another place.

3. The antenna element according to claim 1, further comprising
a second dielectric formed on a surface of the conductor portion except for a place having higher electric field intensity during the operation than that of another place, and wherein
the thickness of the second dielectric is thinner than that of the first dielectric.

4. An antenna comprising: the antenna element according to claim 1; and a reflection plate disposed at an interval with the antenna element, wherein
the conductor portion is a split ring conductor having a shape in which a part of a ring is cut by a split portion,
the first dielectric is connected in such a way as to cover at least a split portion of the split ring conductor and a surface of both end portions in a longitudinal direction of the split ring conductor,
the antenna element further includes
a connection conductor including one end electrically connected to the split ring conductor, and another end portion electrically connected to the reflection plate, and
a feeding line including one end electrically connected to the split ring conductor, and
the feeding line overlaps a region of the connection conductor surrounded by an outer edge across an opening formed in the split ring conductor.

5. The antenna according to claim 4, wherein
both ends of the split ring conductor sandwiching the split portion are extended toward the connection conductor side, and the first dielectric is formed on a surface of the extended conductor.

6. The antenna according to claim 4, wherein
a shape of the split ring conductor is a shape having a plurality of longitudinal sides in a direction parallel to a surface of the reflection plate on a side on which the antenna element is disposed,
the split portion is provided in a vicinity of a center of a first longitudinal side of the split ring conductor, and
the connection conductor is electrically connected to a vicinity of a center of a second longitudinal side of the split ring conductor.

7. The antenna according to claim 4, wherein
the first dielectric is formed only on the split portion.

8. The antenna according to claim 4, wherein
the first dielectric is formed only on the split portion and one end portion in a longitudinal direction of the split ring conductor.

9. The antenna according to claim 4, wherein
the first dielectric is formed only on the split portion and both end portions in a longitudinal direction of the split ring conductor.

10. The antenna according to claim 4, wherein
at least the split ring conductor, the connection conductor, and the feeding line are disposed in a layer provided on a dielectric substrate.

11. The antenna according to claim 10, further comprising:
at least one of a second split ring conductor and a second connection conductor in a layer of the dielectric substrate different from a layer in which the split ring conductor and the connection conductor are disposed; and
at least either of a plurality of conductor vias that electrically connect the split ring conductor and the second split ring conductor, and a plurality of conductor vias that electrically connect the connection conductor and the second connection conductor.

12. The antenna according to claim 11, further comprising
a plurality of the split ring conductors electrically connected with the plurality of conductor vias and disposed in a different layer of the dielectric substrate, wherein
only a split ring conductor disposed in an inner layer of the dielectric substrate among the split ring conductors includes a conductor portion that faces in a vicinity in the split portion, and, furthermore, a length in a longitudinal direction of a split ring conductor disposed in a layer of a surface of the dielectric substrate is shorter than a length in a longitudinal direction of a split ring conductor disposed in an inner layer.

13. The antenna element according to claim 1, wherein
the antenna element is a dipole antenna element, and the first dielectric is formed in a place where two conductors constituting the dipole antenna element face each other and a tip of each of the two conductors.

14. An antenna comprising the antenna element according to claim 1, wherein
a thickness of the first dielectric is equal to or less than 2 mm.

15. The antenna element according to claim 1, wherein
a surface of the first dielectric has water repellency.

16. An array antenna comprising the antenna according to claim 4, wherein
a plurality of the antenna elements are arranged in a one-dimensional or two-dimensional array pattern on the reflection plate.

17. A wireless communication device comprising the antenna element according to claim 1.

18. The wireless communication device according to claim 17, further comprising:
a radome that forms a ventilation flow path between the reflection plate and the radome, and includes an intake hole and an exhaust hole that communicate with the ventilation flow path; and
a communication circuit that excites the array antenna, and also transmits and receives a wireless signal via the array antenna.

19. An array antenna comprising the antenna element according to claim 13, wherein
a plurality of the antenna elements are arranged in a one-dimensional or two-dimensional array pattern on the reflection plate.

20. A wireless communication device comprising the antenna according to claim 4.
